(19) United States
(12) Patent Application Publication
(10) Pub. No.: US 2014/0044611 A1
(43) Pub. Date: Feb. 13, 2014

(54) REAGENT CONTAINER

(71) Applicant: Sysmex Corporation, Kobe-shi (JP)

(72) Inventors: Kinya UCHIHASHI, Kobe-shi (JP); Tatsuya NARIKAWA, Kobe-shi (JP); Yusuke MORI, Kobe-shi (JP); Kenichi MIZUTANI, Kobe-shi (JP); Fuminari HASEGAWA, Kobe-shi (JP)

(73) Assignee: Sysmex Corporation, Kobe-shi (JP)

(21) Appl. No.: 14/058,480

(22) Filed: Oct. 21, 2013

Related U.S. Application Data
(63) Continuation of application No. PCT/JP2012/059387, filed on Apr. 5, 2012.

(30) Foreign Application Priority Data
Apr. 22, 2011 (JP) 2011-096374

(51) Int. Cl. B01L 3/00

(52) U.S. Cl. CPC B01L 3/52
USPC 422/547

(57) ABSTRACT

This reagent container comprises a container body for storing a liquid reagent employed for an analyzer and a band-like grasp portion mounted on the container body so that the user grasps the container body in a suspended state, and the grasp portion includes a band-like member whose first and second end sides are mounted on the container body and a protective member provided on the band-like member to project from an edge portion of the band-like member.

### RELATED APPLICATIONS

This application is a continuation of PCT/JP2012/059387 filed on Apr. 5, 2012, which claims priority to the Japanese Application No. 2011-096374 filed on Apr. 22, 2011. The entire contents of these applications are incorporated herein by reference.

### BACKGROUND OF THE INVENTION

1. Field of the Invention

The present invention relates to a reagent container, and more particularly, it relates to a reagent container for storing a liquid reagent employed for an analyzer.

2. Description of the Background Art

In general, various types of liquid reagents are used in an analyzer. Depending on measurement items of the analyzer or the throughput of the analyzer, a reagent container storing a liquid reagent of a somewhat large quantity of about 5 liters, for example, may be employed. Such a container enlarges both in weight and volume, and hence handling such as transportation has been inconvenient. A container described in Japanese Patent Laid-Open No. 6-345077 is known as a technique of improving handling of such a large-sized liquid container.

A container having a tapelike handle is disclosed in the aforementioned Japanese Patent Laid-Open No. 6-345077. This container has a rectangular parallelepiped shape, and has a volume of at least 3 to 5 liters. The tapelike handle is made of synthetic resin, and both ends of the tapelike handle are stuck to portions close to upper end portions of a pair of opposed side surfaces of the container. Thus, the tapelike handle is provided to extend over the upper surface of the container, and it is possible for the user to carry the reagent container in a suspending manner by grasping the handle.

### SUMMARY OF THE INVENTION

The scope of the present invention is defined solely by the appended claims, and is not affected to any degree by the statements within this summary.

A first aspect of the present invention is a reagent container comprising:

a container body for storing a liquid reagent employed for an analyzer; and

a band-like grasp portion mounted on the container body, wherein

the grasp portion includes a band-like member whose first and second end sides are mounted on the container body and a protective member provided on the band-like member to project from an edge portion of the band-like member.

### BRIEF DESCRIPTION OF THE DRAWINGS

FIG. 1 is a perspective view showing the appearance of a reagent container according to an embodiment of the present invention;

FIG. 2 is a front elevational view of the reagent container according to the embodiment shown in FIG. 1;

FIG. 3 is a top plan view of the reagent container according to the embodiment shown in FIG. 1;

FIG. 4 is a side elevational view of the reagent container according to the embodiment shown in FIG. 1;

FIG. 5 is a perspective view showing a state where the reagent container shown in FIG. 1 is connected with an analyzer;

FIG. 6 is a bottom plan view showing a grasp portion of the reagent container according to the embodiment shown in FIG. 1;

FIG. 7 is an enlarged sectional view showing the grasp portion of the reagent container according to the embodiment shown in FIG. 1;

FIG. 8 is a diagram showing a state of folding the reagent container shown in FIG. 1 when disposing the same;

FIG. 9 is an enlarged sectional view showing a grasp portion in a first modification of the reagent container according to the embodiment of the present invention;

FIG. 10 is an enlarged sectional view showing a grasp portion in a second modification of the reagent container according to the embodiment of the present invention;

FIG. 11 is an enlarged sectional view showing a grasp portion in a third modification of the reagent container according to the embodiment of the present invention; and

FIG. 12 is a perspective view for illustrating a grasp portion in a fourth modification of the reagent container according to the embodiment of the present invention.

### DETAILED DESCRIPTION OF THE PREFERRED EMBODIMENTS

An embodiment materializing the present invention is now described on the basis of the drawings. The dimensions and the content weight of a reagent container disclosed in the following embodiment are mere examples, and the present invention is not restricted to these.

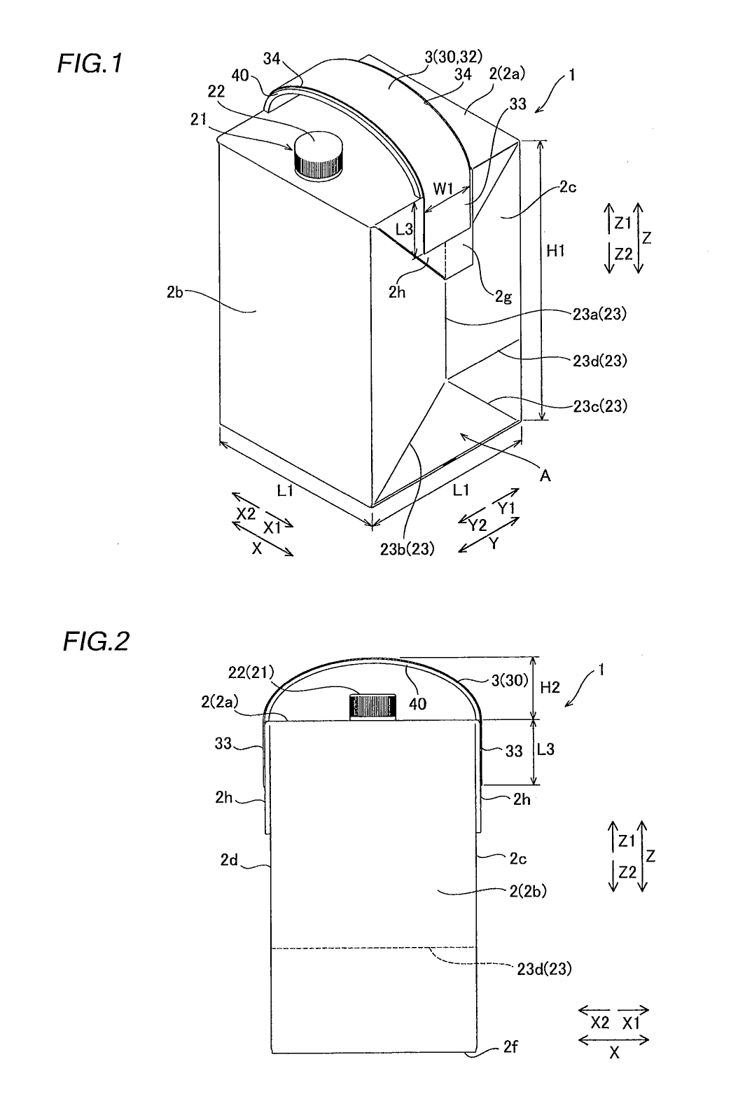

First, the overall structure of a reagent container 1 according to the embodiment of the present invention is described with reference to FIGS. 1 to 8.

The reagent container 1 according to this embodiment stores a liquid reagent employed for an analyzer performing sample analysis. The reagent container 1 includes a container body 2 storing the liquid reagent and a band-like grasp portion 3 to be grasped by the user in a state suspending the container body 2, as shown in FIG. 1. The liquid reagent such as a diluent or a hemolyzer for a blood cell counter, which is an example of the analyzer, for example, is stored in the container body 2.

The container body 2 has the shape of a rectangular parallelepiped with a width as well as a depth L1 and a height H1. The container body 2 is configured to be capable of storing the liquid reagent of about 4 liters. The container body 2 is made of a sheetlike material including a paper material, and formed by a sheetlike composite in which polyethylene, paper and a barrier film etc. are stacked, for example. The container body 2 has an upper surface 2a, a front surface 2b, side surfaces 2c and 2d, a back surface 2e and a bottom surface 2f, as shown in FIGS. 1 to 4.

The container body 2 is provided in the form of the substantially rectangular parallelepiped shown in FIG. 1 by bringing the same into the shape of a substantially rectangular parallelepiped having an opened upper end, thereafter bringing the same into a closed structure by bonding the upper end (the open end) on bonded portions 2g, folding remaining extensional portions 2h toward the sides of both side surfaces 2c and 2d respectively and bonding the same. Various types of prints (not shown) such as the type and the product name of the stored liquid reagent are applied to the respective side surfaces (the front surface 2b and the side surfaces 2c and 2d).

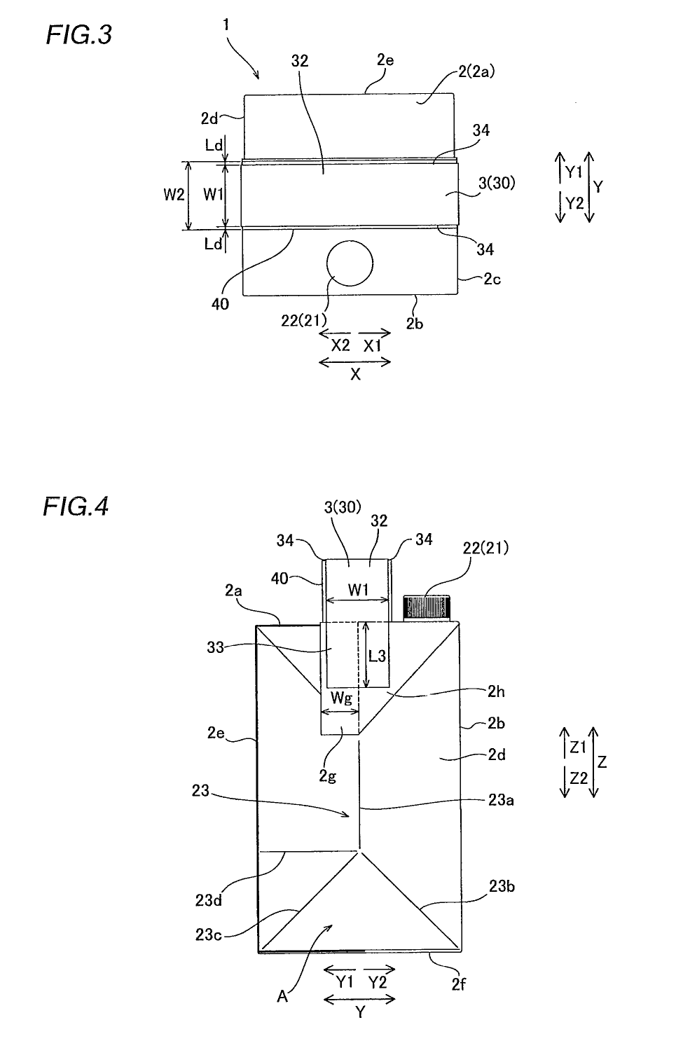

A connecting port 21 for fluidly connecting the analyzer (not shown) and the container body 2 with each other is provided on the upper surface 2a of the container body 2. The connecting port 21 is formed to protrude upward (in a Z1 direction) from the upper surface 2a, and mounted with a cap 22 for opening/closing. As shown in FIG. 3, the connecting port 21 is arranged on a position deviating toward the side of the front surface 2b (the side of a Y2 direction) from the center of the upper surface 2a in plan view, and the connecting port 21 is arranged on a position not overlapping the grasp portion 3 in the vertical direction (a Z direction). In use of the reagent container 1, a connector 50 of the analyzer is connected to the connecting port 21 after the cap 22 (see FIG. 1) is detached from the connecting port 21, as shown in FIG. 5. The connector 50 communicates with a tube 51 and has a suction tube (not shown) connected to the connector 50 to extend downward in the container body 2, so that the suction tube is inserted into the container body 2 when the user connects the connector 50 to the connecting port 21. In use of the analyzer, the reagent in the container body 2 is sucked into the analyzer through the suction tube in the container body 2, the connector 50 and the tube 51. Those having structures disclosed in Japanese Patent Laid-Open No. 9-297146 and U.S. Patent Application Publication No. 2005/0191211, for example, can be employed as such a suction tube and the connector. Once the connector 50 is connected to the connecting port 21 in order to use the analyzer, the same is used in the connected state until the reagent in the reagent container 1 is used and the user exchanges the reagent container 1 next.

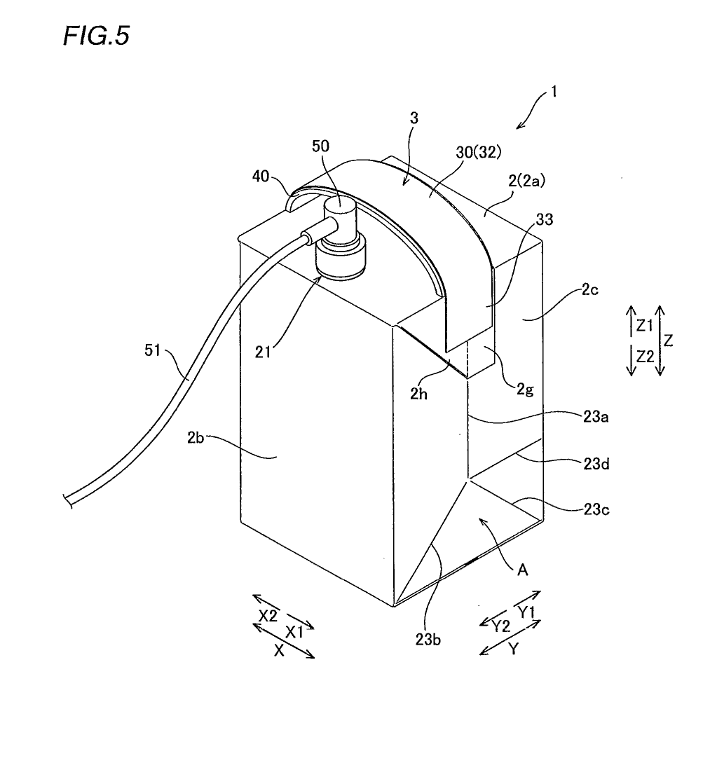

The container body 2 is provided with folds 23 for folding the container body 2 and changing the shape in disposal. More specifically, folds 23a vertically extending centers in a Y direction up to prescribed positions as well as folds 23b and 23c obliquely extending from both corner portions on the side of the bottom surface 2f up to lower ends of the folds 23a respectively are formed on both side surfaces 2c and 2d, as shown in FIGS. 1 and 4. Further, a fold 23d extending toward the side of the back surface 2e from joint portions of the folds 23a to 23c to connect both side surfaces 2c and 2d with each other across the back surface 2e (see FIG. 2) is formed on the container body 2.

As shown in FIGS. 1 to 4, the grasp portion 3 includes a band-like member 30 and a protective member 40 provided to project from both edge portions 34 on the longitudinal side of the band-like member 30 respectively. Both ends of the band-like member 30 are so bonded to the side surfaces 2c and 2d of the container body 2 that the grasp portion 3 is mounted on the container body 2. The grasp portion 3 is configured to be separable from the container body 2 by removing the band-like member 30 in disposal.

As shown in FIG. 2, the grasp portion 3 is so provided that the band-like member 30 is in the form of an arc extending over the upper surface 2a of the container body 2 from a first end side (the side of the side surface 2c) to a second end side (the side of the side surface 2d). Therefore, the grasp portion 3 separates from the upper surface 2a of the container body 2 by the maximum height H2 at the center in the longitudinal direction. The height H2 is set to such a magnitude that the user easily inserts his/her hand between the grasp portion 3 and the upper surface 2a when grasping the grasp portion 3. As shown in FIG. 3, the grasp portion 3 is arranged on a central portion of the container body 2 in the anteroposterior direction (the Y direction).

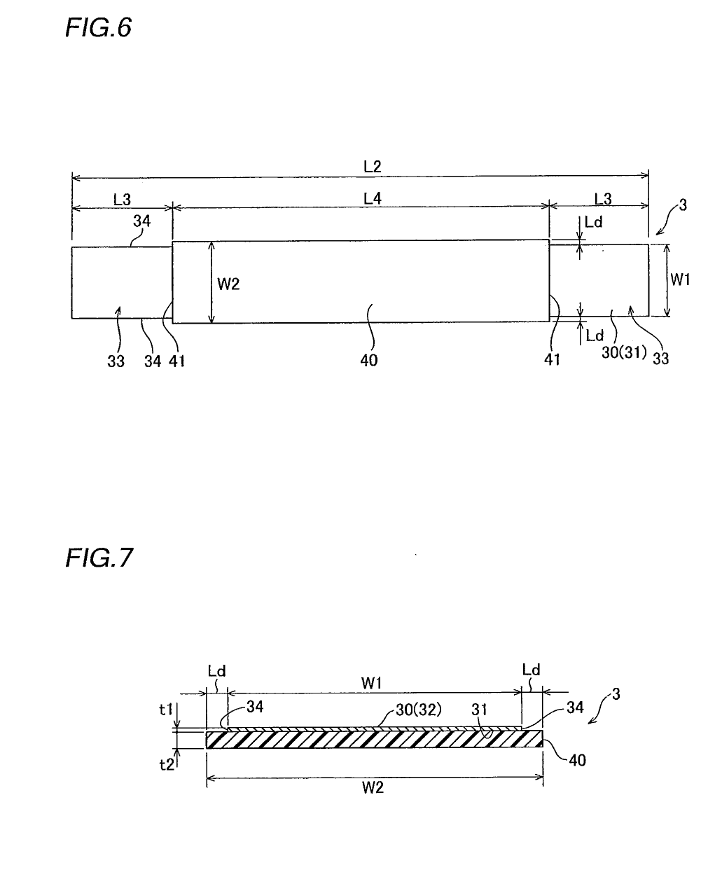

As shown in FIGS. 6 and 7, the band-like member 30 has a length (the length in the longitudinal direction) L2, a width (the length in the short-side direction) W1 and a thickness t1. The band-like member 30 is made of synthetic paper, having a thickness (t1=) of about 0.1 mm, mainly made of a polypropylene-based resin material. An adhesive is applied to the band-like member 30 over the whole of one surface (a lower surface 31). Therefore, the lower surface 31 of the band-like member 30 serves as an adhesive surface, and the band-like member 30 is bonded to both side surfaces 2c and 2d of the container body 2 on the side of this lower surface 31. No adhesive is applied to an upper surface 32 of the band-like member 30.

In the band-like member 30, regions of a length L3 on both ends serve as bonded regions 33 with respect to the container body 2. The length L3 of the bonded regions 33 is larger than the width W1 of the band-like member 30. As shown in FIG. 2, the band-like member 30 is so configured that bond strength in directions (the Z direction and the Y direction) parallel to bonded surfaces is larger than bond strength in a normal direction (an X direction) orthogonal to the bonded surfaces (the side surfaces 2c and 2d). The band-like member 30 is bonded with bond strength capable of sufficiently supporting the weight of the container body 2 acting in the Z direction in a case where the user suspends the reagent container 1 by grasping the grasp portion 3. When the user disposes the reagent container 1, on the other hand, it is possible to easily separate the grasp portion 3 from the container body 2 by pulling off the band-like member 30 in the normal direction (the X direction) orthogonal to the bonded surfaces (the side surfaces 2c and 2d). The bonded regions 33 are examples of the “mounted region” and the “bonded surface with respect to the container body” in the present invention.

As shown in FIGS. 1 and 4, the band-like member 30 is so formed that the width W1 thereof is larger than the width Wg of the bonded portions 2g of the container body 2, and the band-like member 30 is bonded to partially overlap the bonded portions 2g in regions wider than the bonded portions 2g on both side surfaces 2c and 2d (the extensional portions 2h). The extensional portions 2h, configured to overlap the side surface 2c (2d), are portions resistant against deformation in the container body 2. Therefore, the band-like member 30 is so bonded to the extensional portions 2h that the container body 2 can be inhibited from remarkably deforming when the user grasps the band-like member 30 to grasp the reagent container 1 in a suspended state.

The protective member 40 is provided in order to protect fingers of the user when he/she grasps the grasp portion 3. As shown in FIGS. 6 and 7, the protective member 40 has a length (the length in the longitudinal direction) L4 and a width (the length in the short-side direction) W2, and is provided in the form of a sheet having a thickness t2. The protective member 40 is made of expanded polyethylene of a thickness (t2 of about 2 mm having elasticity.

The protective member 40 is bonded to the lower surface 31 of the band-like member 30 opposed to the upper surface 2a of the container body 2, and fixed to the band-like member 30. More specifically, the protective member 40 is stuck to a bonded region of the length L4 (L4=L2−(2×L3)) at the center of the band-like member 30. In other words, the protective member 40 is provided substantially on the whole of the lower surface 31 excluding the bonded regions 33 of the band-like member 30 to the container body 2.

According to this embodiment, the protective member 40 is provided to project from both edge portions 34 on the longitudinal side of the band-like member 30 by a length Ld respectively. More specifically, the protective member 40 is so formed that the width W2 thereof is larger than the width W1 of the band-like member. The protective member 40 is bonded to the band-like member 30 in a state of matching the center in the width direction (the short-side direction) with the band-like member 30. Therefore, the protective member 40 projects in the short-side direction by the length Ld (Ld=(W2−W1)/2) responsive to the difference between the width W2 and the width W1.

When forming (cutting) a sheetlike member such as the protective member 40 in prescribed dimensions, waviness is frequently caused on a cut surface in either the longitudinal direction or the short-side direction. This waviness influences dimensional accuracy by expansion and contraction in the waviness direction. Therefore, the protective member 40 is so formed that waviness in the short-side direction appears on end surfaces 41. Thus, dimensional dispersion in the longitudinal direction of the protective member 40 is suppressed. The protective member 40 may simply project in the short-side direction from the edge portions 34 of the band-like member 30 in consideration of functions of the protective member 40 while the width W2 is sufficiently small as compared with the length L4, and hence there is hardly influence by dimensional dispersion resulting from waviness in the short-side direction of the protective member 40. Also in consideration of dimensional dispersion on the short side (in the width direction) resulting from waviness, the length Ld of the projecting portions of the protective member 40 is set to be at least about 1 mm and to be about several mm.

A folding procedure in disposal of the reagent container 1 is now described with reference to FIGS. 1 to 3 and 8.

First, the user raises the extensional portions 2h while removing the same from both side surfaces 2c and 2d (see FIG. 2) respectively, in the state of FIG. 1. Then, the user raises the bonded portions 2g from the upper surface 2a, and thereafter flatly folds the upper portion of the container body 2 to match two corners of the upper surface 2a on the side of the front surface 2b and two corners on the side of the back surface 2e (see FIG. 3) with each other. Then, the user mountain-folds centers of both side surfaces 2c and 2d in the Y direction along the folds 23a in the vertical direction, from the flattened upper portion toward the lower portion. In other words, the user doubles both side surfaces 2c and 2d along the folds 23a so that the front surface 2b and the back surface 2e coincide with each other.

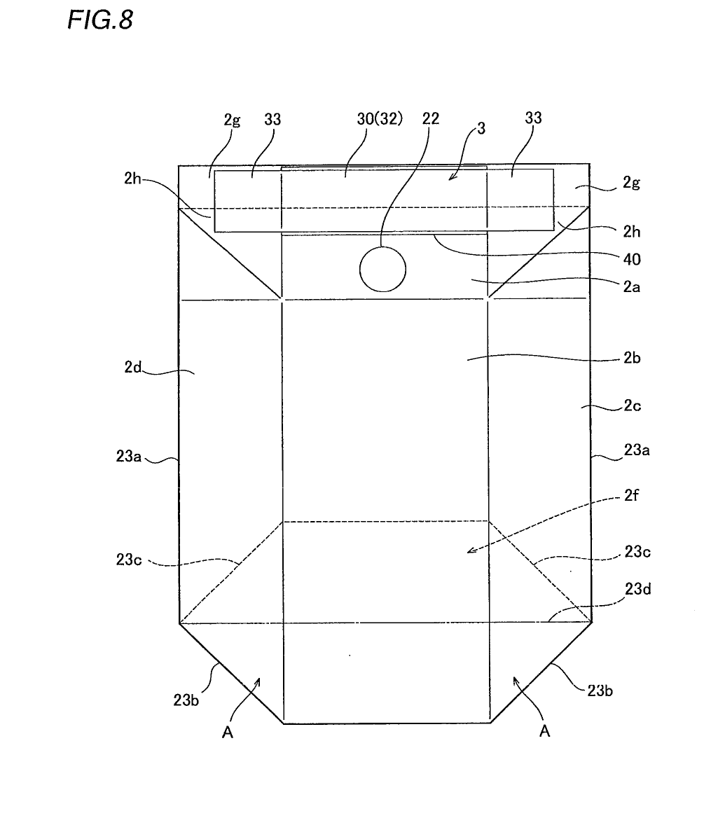

Further, the user folds triangular side surface portions A surrounded by the obliquely extending folds 23b and 23c up to the bottom surface 2f (a set surface) outwardly in the X direction. At this time, the bottom portion of the reagent container 1 gets hexagonal (see FIG. 8) on the bottom surface 2f and the triangular side surface portions A on both sides of the bottom surface 2f in the X direction.

Finally, the user folds halves of the hexagonal portions formed by the side surface portions A and the bottom surface 2f on the side of the back surface 2e along the folds 23d. Thus, the reagent container 1 is deformed into a flat folded state shown in FIG. 8. While the reagent container 1 is folded in a state leaving the grasp portion 3 in FIG. 8 in order to facilitate easy understanding of the positional relation between the respective portions, the grasp portion 3 may be separated by removing the band-like member 30 before deforming the reagent container 1 or after deforming the same.

According to the technique described in the aforementioned Japanese Patent Laid-Open No. 6-345077, there is a possibility that the handle so bites into fingers of the user due to the weight of the container that the user feels a pain or hurts the skin of the fingers when the user raises the container by grasping the tapelike handle. Therefore, there is such a problem that transportation of the reagent container heavy with a large content weight is not easy.

According to this embodiment, as hereinabove described, the grasp portion 3 is provided with the band-like member 30 whose first and second end sides are mounted on the container body 2 and the protective member 40 provided on the band-like member 30 to project from the edge portions 34 on the longitudinal side of the band-like member 30, whereby the user can transport the reagent container 1 by grasping both of the band-like member 30 and the protective member 40. Thus, biting of the grasp portion 3 into the fingers of the user is suppressed by the protective member 40 and the user can be inhibited from feeling a pain. Further, the protective member 40 projects from the edge portions 34 on the longitudinal side of the band-like member 30, whereby the protective member 40 can be reliably interposed between the edge portions 34 of the band-like member 30 and the fingers of the user. Consequently, the edge portions 34 of the band-like member 30 can be inhibited from hurting the fingers of the user. From the above, the user can easily transport the reagent container 1 also in a case where the reagent container 1 is heavy with a large content weight in the reagent container 1 according to this embodiment.

According to this embodiment, as hereinabove described, the protective member 40 is so formed that the width W2 thereof is larger than the width W1 of the band-like member 30 while the protective member 40 is provided to project from both edge portions 34 on the longitudinal side of the band-like member 30 respectively, whereby the protective member 40 can be reliably interposed between the fingers of the user and both edge portions 34 of the band-like member 30. Thus, the fingers of the user can be prevented from being cut or the like by the edge portions 34 of the thin band-like member 30, whereby the fingers of the user can be more effectively be inhibited from being hurt when grasping the grasp portion 3.

According to this embodiment, as hereinabove described, the protective member 40 is so provided on the lower surface 31 of the band-like member 30 that the protective member 40 is arranged on the surface onto which the weight of the reagent container 1 is applied when the user grasps the grasp portion 3, whereby biting of the grasp portion 3 into the fingers of the user can be more effectively suppressed.

According to this embodiment, as hereinabove described, the protective member 40 is provided substantially on the whole of the lower surface 31 of the band-like member 30 excluding the bonded regions 33 of the band-like member 30 to the container body 2, whereby the grasp portion 3 can be reliably inhibited by the protective member 40 from biting into the fingers of the user, regardless of a grasped position of the grasp portion 3.

According to this embodiment, as hereinabove described, the protective member 40 is provided in the form of a sheet made of expanded polyethylene having elasticity, whereby the sheetlike protective member 40 can be easily provided on the band-like member 30. Further, a load applied to the fingers of the user can be relaxed due to the elasticity of the protective member 40. In addition, the protective member 40 is so made of the expanded polyethylene that a protective member lightweight and excellent in elasticity (shock absorptivity) can be provided on the grasp portion 3. Thus, biting of the grasp portion 3 into the fingers of the user is effectively suppressed by the protective member 40 made of the expanded polyethylene, whereby the user can be more effectively inhibited from feeling a pain when transporting the reagent container 1 by grasping the grasp portion 3.

According to this embodiment, as hereinabove described, the band-like member 30 made of synthetic paper mainly made of the polypropylene-based resin material is so provided that the grasp portion 3 can be rendered lightweight. Further, material consumption can be reduced as compared with a case of forming the grasp portion 3 by a resin-molded member or the like, whereby a load on the environment can be reduced.

According to this embodiment, as hereinabove described, the container body 2 made of a sheetlike composite including a paper material is so provided that the reagent container 1 can be easily rendered lightweight.

According to this embodiment, as hereinabove described, the folds 23 (23a to 23d) for changing the shape in disposal are so provided on the container body 2 that the container body 2 can be folded and compactified in disposal of the reagent container 1. Consequently, the volume in disposal decreases, whereby the load on the environment can be reduced also by this.

According to this embodiment, as hereinabove described, the extensional portions 2h in which the sheetlike composite is folded over the side surface 2c (2d) are provided on the container body 2, and the band-like member 30 is mounted on the extensional portions 2h of the container body 2. Thus, the extensional portions 2h over which the sheetlike composite is folded are resistant against deformation, whereby deformation of the container body 2 can be suppressed also in a case where the user suspends the container body 2 by grasping the grasp portion 3.

According to this embodiment, as hereinabove described, the grasp portion 3 is provided on the container body 2 to be arcuate from the first end toward the second end of the band-like member 30, whereby a clearance can be ensured between the grasp portion 3 and the upper surface 2a of the container body 2 by the height H2. Thus, the user can easily insert his/her hand into this clearance, whereby he/she can easily handle the reagent container 1.

According to this embodiment, as hereinabove described, the grasp portion 3 is mounted to be separable from the container body 2 in disposal, whereby the grasp portion 3 and the container body 2 can be separately disposed by separating the grasp portion 3 in disposal, also when the container body 2 and the grasp portion 3 are made of different materials.

According to this embodiment, as hereinabove described, the band-like member 30 is mounted on the side surfaces 2c and 2d of the container body 2 with the adhesive and so bonded that the bond strength in the directions (the Y direction and the Z direction) parallel to the bonded surfaces is larger than the bond strength in the normal direction (the X direction) orthogonal to the bonded surfaces, whereby the grasp portion 3 can be easily separated from the container body 2. Also in this case, the user can transport the reagent container 1 without detaching the grasp portion 3 from the container body 2 when transporting the same by grasping the grasp portion 3.

According to this embodiment, as hereinabove described, the length L3 of the bonded regions 33 to the container body 2 in the longitudinal direction of the band-like member 30 is rendered larger than the width W1 in the short-side direction of the band-like member 30. Thus, the bond strength of the bonded surfaces to the longitudinal direction (the Z direction in FIG. 1) of the band-like member 30 can be increased. The longitudinal direction of the band-like member 30 is the direction parallel to the bonded surfaces and the direction in which force acts in a case where the container body 2 is suspended through the grasp portion 3, whereby the grasp portion 3 can be effectively inhibited from coming off the container body 2 in transportation.

According to this embodiment, as hereinabove described, the connecting port 21 for fluidly connecting the container body 2 and the analyzer with each other is provided on the container body 2, whereby the container body 2 and the analyzer can be connected with each other as such also in a case where the reagent container 1 is heavy with a large content weight. Therefore, the user can easily handle the reagent container 1 without requiring an operation of exchanging the liquid reagent or the like.

According to this embodiment, as hereinabove described, the connecting port 21 is arranged on the position not overlapping the grasp portion 3 on the upper surface 2a of the container body 2 in plan view so that the grasp portion 3 does not hinder when the user connects the connecting port 21 to the side of the analyzer, whereby workability at the time of connecting the connecting port 21 to the side of the analyzer can be improved.

According to this embodiment, as hereinabove described, the container body 2 substantially in the form of a rectangular parallelepiped is so provided that reagent containers 1 can be lined up with no clearance in transportation. Thus, transportation efficiency for the reagent containers 1 increases, whereby a load on the environment can be reduced.

In this embodiment, as hereinabove described, the example in which the present invention is applied to the reagent container storing the liquid reagent (a diluent or a hemolyzer) for a blood cell counter has been shown. Thus, transportation or handling of the reagent container 1 used for the blood cell counter employing a relatively large quantity of reagent becomes easy. Further, the diluent or the hemolyzer is generally used in a relatively large quantity in the blood cell counter, and hence the reagent container 1 according to this embodiment is particularly effective as a reagent container for a diluent or a hemolyzer.

The embodiment disclosed this time must be considered as illustrative in all points and not restrictive. The range of the present invention is shown not by the above description of the embodiment but by the scope of claims for patent, and all modifications within the meaning and range equivalent to the scope of claims for patent are included.

For example, while the example of applying the present invention to the reagent container storing the liquid reagent (a diluent or a hemolyzer) for the blood cell counter has been shown in the aforementioned embodiment, the present invention is not restricted to this. For example, the present invention may be applied to a reagent container for a liquid reagent employed for a urine visible component analyzer. Further, a reagent other than the diluent or the hemolyzer may be stored as the liquid reagent. For example, the liquid reagent may be a detergent or a sheath liquid.

While the example of forming the container body by the composite in which polyethylene, paper and a barrier film etc. are stacked has been shown in the aforementioned embodiment, the present invention is not restricted to this. According to the present invention, a resin-molded container such as the so-called poly-container or a flexible baglike container made of resin may be employed as the container body. In addition, the container body may be made of a material other than the resin.

While the example of forming the band-like member of the grasp portion by the synthetic paper mainly made of the polypropylene-based resin material has been shown in the aforementioned embodiment, the present invention is not restricted to this. According to the present invention, the band-like member may be made of synthetic resin mainly made of a resin material other than the polypropylene-based material or a paper material other than the synthetic paper. Further, the band-like member may be made of a material other than these. A thin, lightweight and strong material is preferable for the band-like member in points of material consumption and easiness of transportation. Also in a case of employing such a thin and strong band-like member, it is possible to protect the fingers of the user with the protective member according to the present invention.

While the example of forming the protective member of the grasp portion by the expanded polyethylene has been shown in the aforementioned embodiment, the present invention is not restricted to this. According to the present invention, the protective member may be made of a foaming resin material other than the expanded polyethylene or a resin material such as a rubber sheet other than the foaming resin material. Further, the protective member may be made of a material other than these.

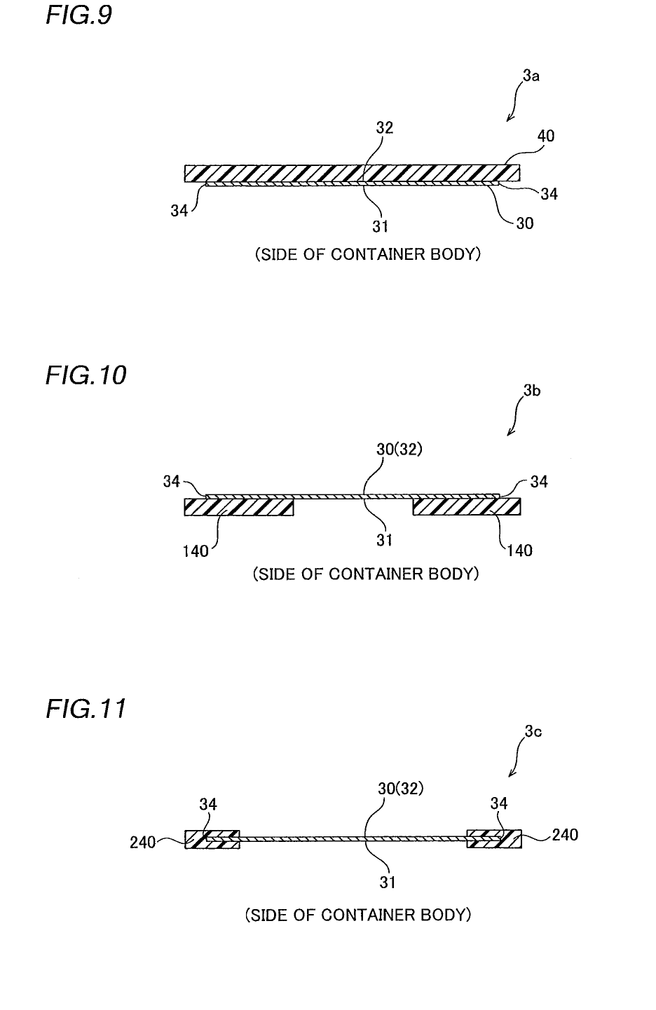

While the example of providing the protective member on the lower surface of the band-like member opposed to the upper surface of the container body has been shown in the aforementioned embodiment, the present invention is not restricted to this. According to the present invention, a protective member 40 may be provided on the side of an upper surface 32 of a band-like member 30, as in a grasp portion 3a according to a first modification shown in FIG. 9. Also when configuring the reagent container 1 in this manner, the protective member 40 can be interposed between edge portions 34 of the band-like member 30 and the fingers of the user to protect the fingers when the user grasps the grasp portion.

While the example of rendering the width W2 of the protective member larger than the width W1 of the band-like member so that the protective member projects from both edge portions of the band-like member respectively has been shown in the aforementioned embodiment, the present invention is not restricted to this. According to the present invention, two protective members 140 may be provided to project from both edge portions 34 of a band-like member 30 respectively, as in a grasp portion 3b according to a second modification shown in FIG. 10. Alternatively, a protective member may be so provided that the protective member projects from only an edge portion on one side of a band-like member. In the case of providing the protective member 40 wider than the band-like member 30 over the whole width of the band-like member 30 as in the aforementioned embodiment, however, the band-like member 30 can be prevented from being creased in the width direction and narrowed in the case where the user grasps the grasp portion 3, whereby a load can be inhibited from concentrating on the fingers of the user.

While the example of making the protective member to project from the edge portions on the side of the lower surface of the band-like member has been shown in the aforementioned embodiment, the present invention is not restricted to this. According to the present invention, protective members 240 may be provided to project from edge portions 34 on both sides of an upper surface 32 and a lower surface 31 of a band-like member 30 to wrap the edge portions 34 of the band-like member 30, as in a grasp portion 3c according to a third modification shown in FIG. 11.

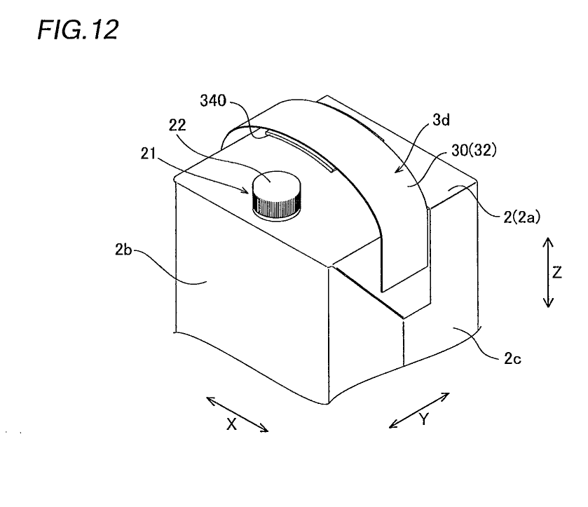

While the example of providing the protective member substantially on the whole surface excluding the bonded regions on the side of the lower surface of the band-like member has been shown in the aforementioned embodiment, the present invention is not restricted to this. According to the present invention, a protective member 340 may be provided only on a prescribed region in the vicinity of a central portion in the longitudinal direction (an X direction) of a band-like member 30, as in a grasp portion 3d according to a fourth modification shown in FIG. 12. When providing the protective member 340 at least on the prescribed region in the vicinity of the central portion in the longitudinal direction of the band-like member 30 as in this fourth modification, the protective member 340 is provided on the central portion of the band-like member 30 having a high possibility of being grasped by the user, whereby the user can be easily made to grasp a region where the protective member 340 is formed when the user grasps the grasp portion 3d. According to the present invention, the protective member may be provided on a portion other than the central portion in the longitudinal direction of the band-like member.

While the example of providing the folds for deforming the reagent container in disposal on the container body has been shown in the aforementioned embodiment, the present invention is not restricted to this. According to the present invention, no folds may be provided on the container body.

While the example of providing the container body in the form of a rectangular parallelepiped has been shown in the aforementioned embodiment, the present invention is not restricted to this. According to the present invention, the container body may be provided in the form of a cylinder or a cube other than the rectangular parallelepiped.

While the example of configuring the grasp portion to be separable in disposal by bonding the same to the side surfaces of the container body has been shown in the aforementioned embodiment, the present invention is not restricted to this. According to the present invention, the grasp portion may be integrally formed on the container body, for example, not to be separable.

What is claimed is:

1. A reagent container comprising:
a container body for storing a liquid reagent employed for an analyzer; and
a band-like grasp portion mounted on the container body, wherein
the grasp portion includes a band-like member whose first and second end sides are mounted on the container body and a protective member provided on the band-like member to project from an edge portion of the band-like member.

2. The reagent container according to claim 1, wherein
the protective member is so formed that the width thereof in the short-side direction of the band-like member is larger than the width in the short-side direction of the band-like member, and
the protective member is provided to project from both edge portions on the longitudinal side of the band-like member respectively.

3. The reagent container according to claim 1, wherein
the protective member is at least provided on a prescribed region in the vicinity of a central portion in the longitudinal direction of the band-like member.

4. The reagent container according to claim 1, wherein
the band-like member comprises a first surface opposed to the upper surface of the container body and a second surface which is the other side of the first surface, and
the protective member is provided on the first surface of the band-like member.

5. The reagent container according to claim 4, wherein
the protective member is provided substantially on the whole of the first surface of the band-like member except for a mounted region of the band-like member onto the container body.

6. The reagent container according to claim 1, wherein
the protective member has elasticity, and is provided in the form of a sheet.

7. The reagent container according to claim 1, wherein
the band-like member is made of synthetic paper.

8. The reagent container according to claim 1, wherein
the protective member is made of a foaming resin material.

9. The reagent container according to claim 1, wherein
the container body is made of a sheetlike material including a paper material.

10. The reagent container according to claim 9, wherein
the container body comprises a fold for changing the shape in disposal.

11. The reagent container according to claim 9, wherein
the container body comprises a side surface portion over which the sheetlike material is folded, and
the first and second end sides of the band-like member are mounted on the side surface portion of the container body.

12. The reagent container according to claim 1, wherein
the grasp portion is mounted on the container body to be arcuate from the first end toward the second end of the band-like member.

13. The reagent container according to claim 1, wherein
the grasp portion is mounted to be separable from the container body.

14. The reagent container according to claim 13, wherein
the band-like member is mounted on a side surface of the container body with an adhesive, and so bonded that bond strength in a direction parallel to a bonded surface is larger than bond strength in a direction orthogonal to the bonded surface.

15. The reagent container according to claim 14, wherein
the length of the bonded surface with respect to the container body in the longitudinal direction of the band-like member is larger than the width in the short-side direction of the band-like member.

16. The reagent container according to claim 1, wherein
the container body comprises a connecting port for fluidly connecting the container body and the analyzer with each other.

17. The reagent container according to claim 16, wherein
the connecting port is arranged on the upper surface of the container body on a position not overlapping the grasp portion in plan view.

18. The reagent container according to claim 1, wherein
the container body has an outer shape substantially in the form of a rectangular parallelepiped.

19. The reagent container according to claim 1, wherein
the liquid reagent is a reagent for a blood cell counter or a reagent for a urine visible component analyzer.

20. The reagent container according to claim 19, wherein
the liquid reagent is a diluent, a hemolyzer or a detergent.
